(19) United States
(12) Patent Application Publication
(10) Pub. No.: US 2014/0305351 A1
(43) Pub. Date: Oct. 16, 2014

(54) Robber trapping door

(71) Applicant: Pierre-Marie Grondin, Beauceville (CA)

(72) Inventor: Pierre-Marie Grondin, Beauceville (CA)

(21) Appl. No.: 13/860,610

(22) Filed: Apr. 11, 2013

(51) Int. Cl. E05G 5/02

(52) U.S. Cl. CPC E05G 5/02
USPC 109/8

(57) ABSTRACT

A robber trapping door has an interior door section adapted to be securely and pivotally attached to an interior surface of a wall member adjacent to an opening therethrough. An exterior door section adapted to be securely and pivotally attached to an exterior surface of the wall member adjacent to the opening therethrough; and a connector member securely connected to the exterior door section, adapted to extend through the opening of the wall member, and is movably connected to the interior door section, such that the interior and exterior door sections can pivotally move in unison with one another. The interior door section includes a stopper mechanism adapted to prevent the interior door section from pivoting with respect to the wall member, and thereby also preventing the exterior door section from pivoting with respect to the wall member, such that when a robber is attempting to pass through the interior and exterior door sections the stopper can be activated locking the door sections in place and trapping the robber therebetween for apprehension.

### FIELD OF THE INVENTION

The present invention relates generally to doorways but more particularly to a door for trapping robbers.

### BACKGROUND OF THE INVENTION

Banks and other types of commerce are the victims of robbery. If the robber could be caught soon after he commits his act, that could increase the number of arrests.

### SUMMARY OF THE INVENTION

It is a main advantage of this invention to provide for a door system that catches robbers. Besides catching robbers, the invention can also be used as a deterrent.

In order to do so, the invention is comprised of an interior door section adapted to be securely and pivotally attached to an interior surface of a wall member adjacent to an opening therethrough. An exterior door section adapted to be securely and pivotally attached to an exterior surface of the wall member adjacent to the opening therethrough; and a connector member securely connected to the exterior door section, adapted to extend through the opening of the wall member, and is movably connected to the interior door section, such that the interior and exterior door sections can pivotally move in unison with one another. The interior door section includes a stopper mechanism adapted to prevent the interior door section from pivoting with respect to the wall member, and thereby also preventing the exterior door section from pivoting with respect to the wall member, such that when a robber is attempting to pass through the interior and exterior door sections the stopper can be activated locking the door sections in place and trapping the robber therebetween for apprehension.

The exterior door section further includes an exterior door adapted to be pivotally attached to the exterior surface of the wall member adjacent to the opening therethrough. An upper frame segment adapted to be securely attached to the exterior surface of the wall member adjacent and above the opening therethrough. An exterior partition member adapted to be fixedly attached to the exterior surface of the wall member adjacent to the opening therethrough and on an opposite side from the exterior door, and wherein the exterior partition is adapted to be fixedly attached to the exterior surface of the wall member at an angle such that the exterior door, the upper frame segment, and the exterior partition member can form a triangular configuration to one another; and an exterior top panel member fixedly attached to top surfaces of the upper frame segment and the exterior partition member, and formed in a triangular shape that matches the triangular shape formed by the exterior door, the upper frame segment, and the exterior partition member when the exterior door is pivoted and locked in place by the stopper mechanism.

The interior door section further includes an interior door adapted to be pivotally attached to the interior surface of the wall member adjacent to the opening therethrough. An upper frame segment adapted to be securely attached to the interior surface of the wall member adjacent and above the opening therethrough. An interior partition member adapted to be fixedly attached to the interior surface of the wall member adjacent to the opening therethrough and on an opposite side from the interior door, and wherein the interior partition is adapted to be fixedly attached to the interior surface of the wall member at an angle such that the interior door, the upper frame segment, and the interior partition member can form a triangular configuration to one another; and an interior top panel member fixedly attached to top surfaces of the upper frame segment and the interior partition member, and formed in a triangular shape that matches the triangular shape formed by the interior door, the upper frame segment, and the interior partition member when the interior door is pivoted and locked in place by the stopper mechanism.

The stopper mechanism includes a stopper attached to the connector member, and a solenoid latch attached to the upper frame member of the interior door section, such that when the stopper mechanism is activated the stopper is securely connected to the solenoid latch, thereby locking the interior and exterior doors in positions that form the triangular shapes, and thereby form a cage that is adapted to trap the robber therein for apprehension.

The interior door has an elongated groove within a tops surface thereof; and the connector member includes a securing lock pin extending downward therefrom that is adapted to fit and slide within the elongated groove of the interior door, thereby forming the movable connection therebetween.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIGS. 1a-b Isometric and detail views of the invention.

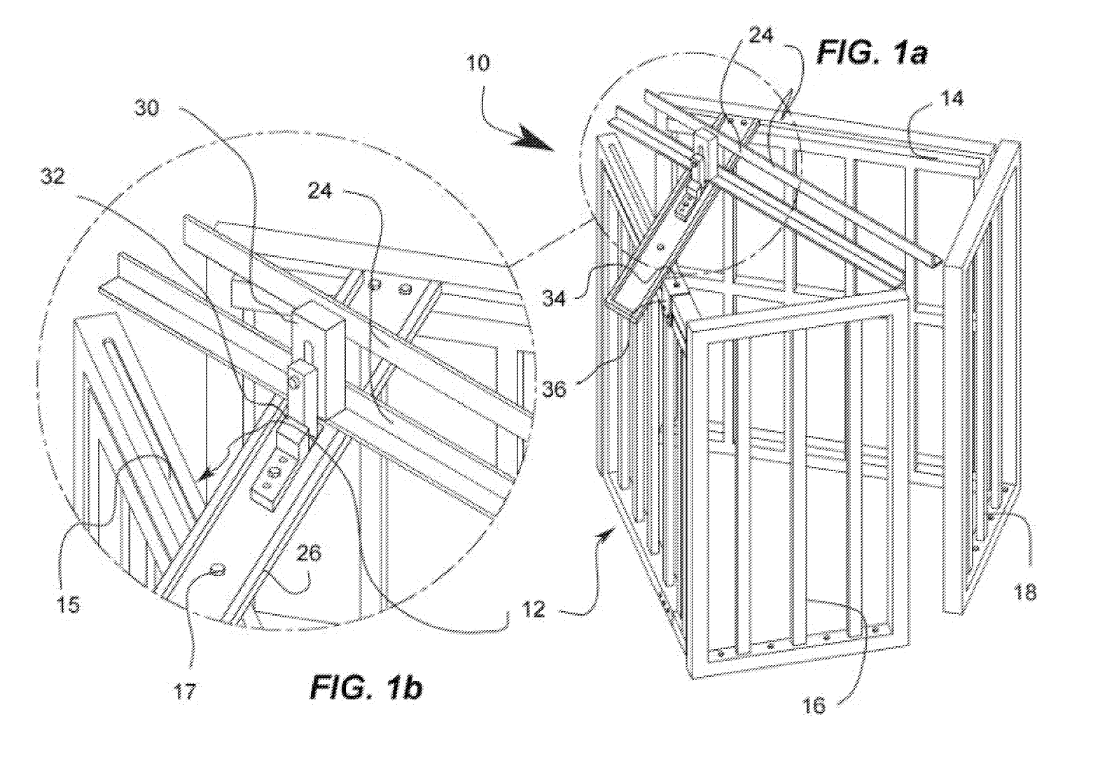

FIG. 2 Isometric view of the invention with top panel members.

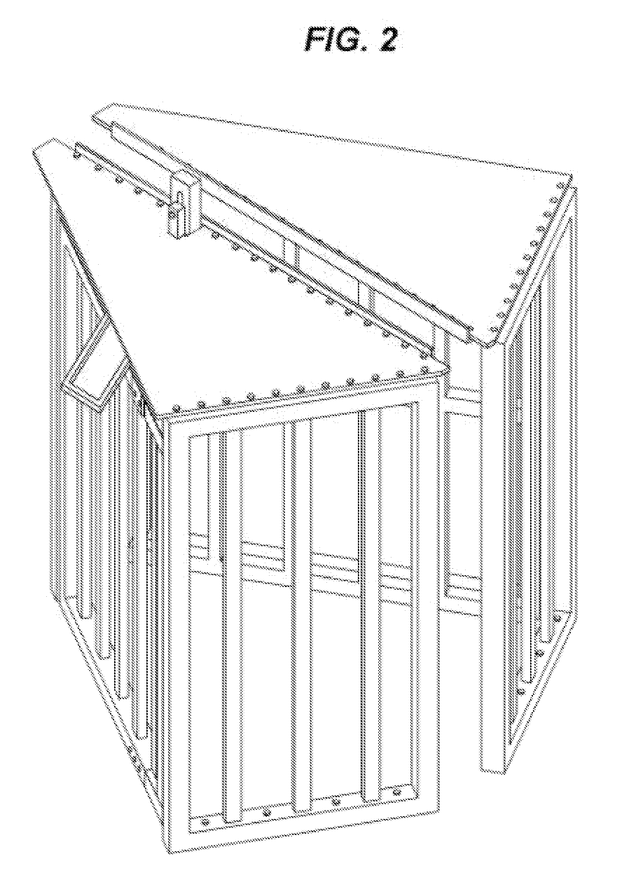

FIG. 3 Isometric view of the invention in delivery mode configuration.

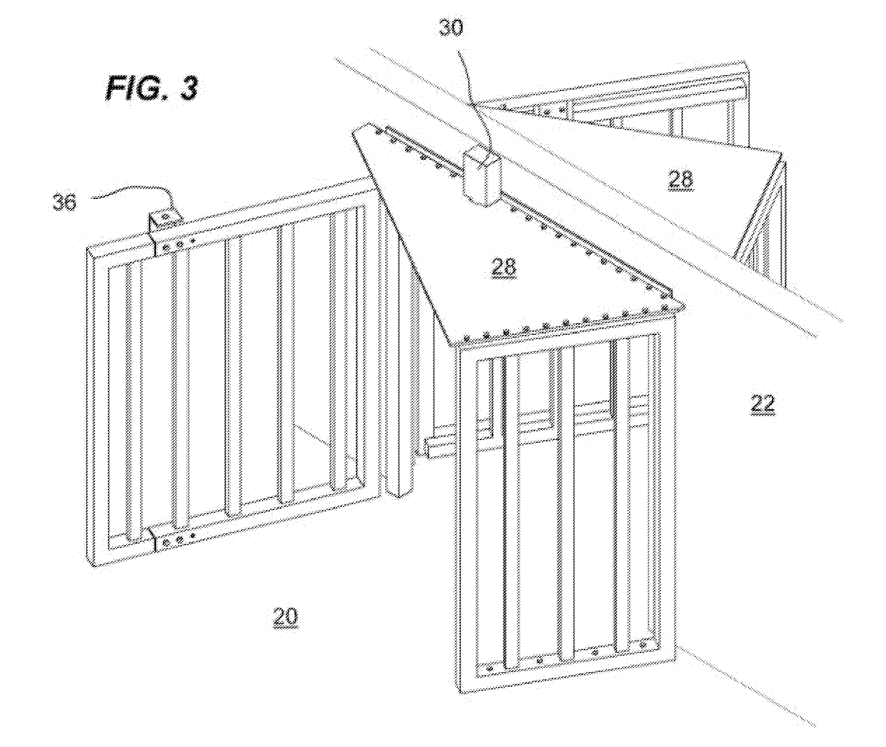

FIGS. 4a-c Top views showing different configurations.

FIG. 5 Exploded view of the invention.

FIG. 6 Same as FIG. 5 but showing the partition members.

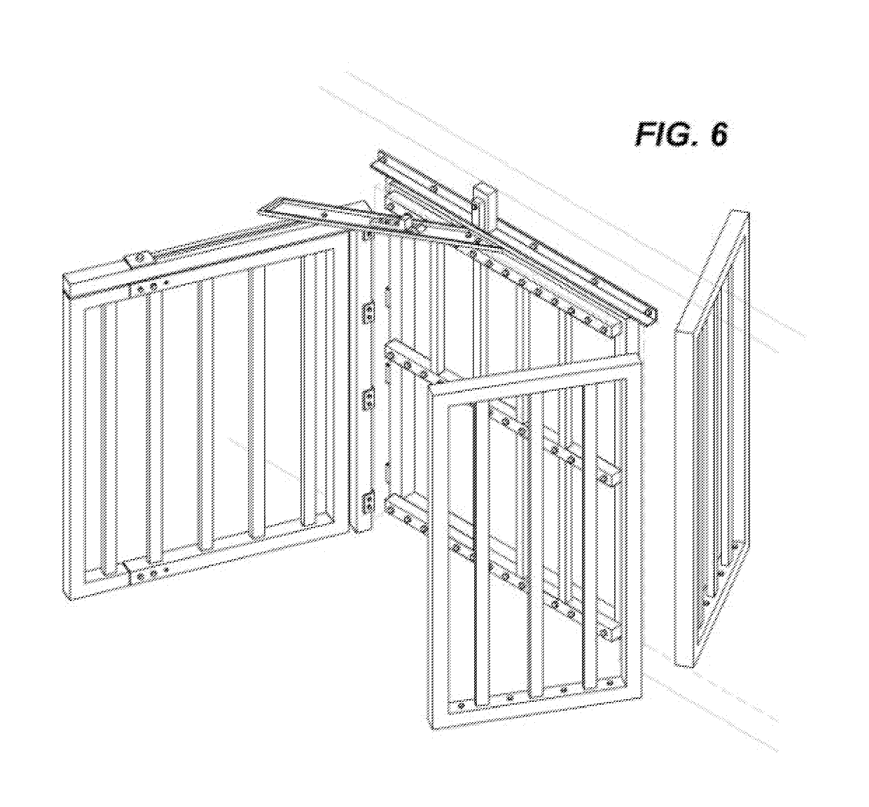

FIG. 7 Isometric view with one door opened.

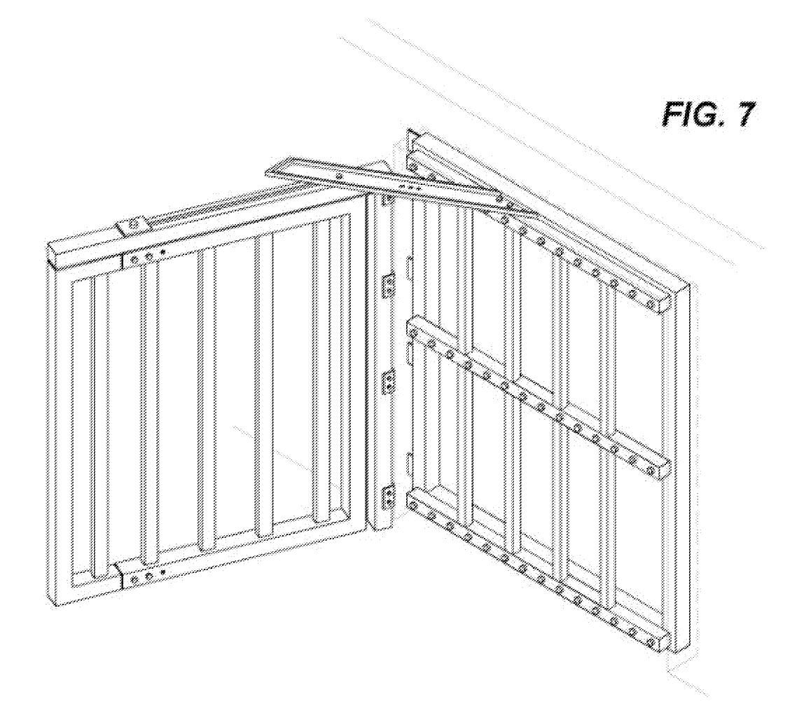

### DETAILED DESCRIPTION

A robber trapping door (10) has a interior door (12) and an exterior door (14). It also has an interior wall section (16) that is to be located in a room on one side of a wall (22), (typically inside a building), and an exterior wall section (18) located on the opposite side of the wall (22), outside the room (20) from where the interior wall section (16) is located.

The trapping door (10) has a frame segment (24) configured for securing it to the existing wall (22).

Both the interior and exterior wall sections (16, 18) are fixed and generally mechanically fastened to the floor so that only the interior and exterior door (12, 14) are movable, as well as a connector member (26) fixedly attached to the exterior door (!4) and slidingly connected to the interior door (12) by way of a pin (17) sliding into a groove (15).

The interior door (12) is further comprised of a frame (13) which is hingedly attached to the wall (22) by way of hinges (23) and the interior door is hingedly attached to the frame (13) by its own door hinges (21).

Top panel members (28) are fixedly attached to the interior and exterior wall sections (16, 18) and the frame segment (24) so as to prevent any possible egress.

A connection member (36) connects the interior door (12) to the frame (13) by way of a securing lock pin (34), unlocking the interior door (12) enables both doors (12,14) to be open at the same time, which is useful for deliveries.

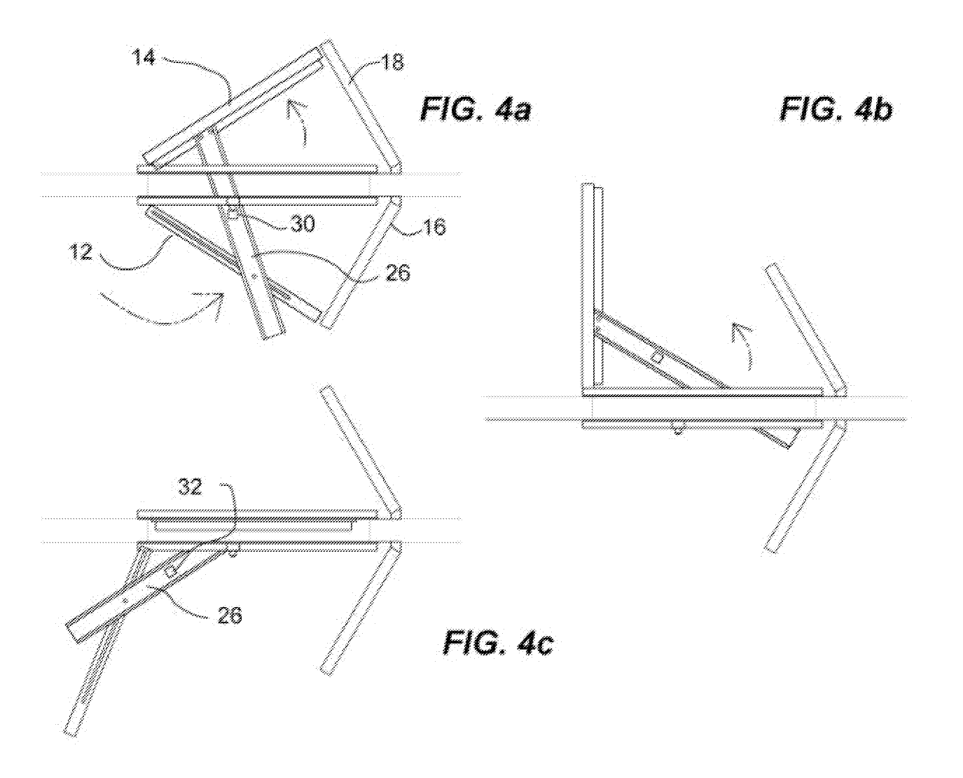

FIGS. 4b-c show the typical configuration wherein users need to push or pull on the interior door (12) or the exterior door (14) for ingress and egress.

FIG. 4a shows the trapping configuration wherein a robber, when pushing the second door (14), in order to get out, also pulls in the first door (12) so that both doors reach their final locked in position which traps the robber.

When a robbery is signaled, a stopper mechanism (32) located on the connector member (26) engages a solenoid latch (30) which locks the connector member (26) in place. The result is that both doors (12, 14) are prevented from moving and locked in the configuration as seen in FIG. 4a, which is that both doors (12, 14), along with the wall sections (16, 18), prevent any ingress or egress.

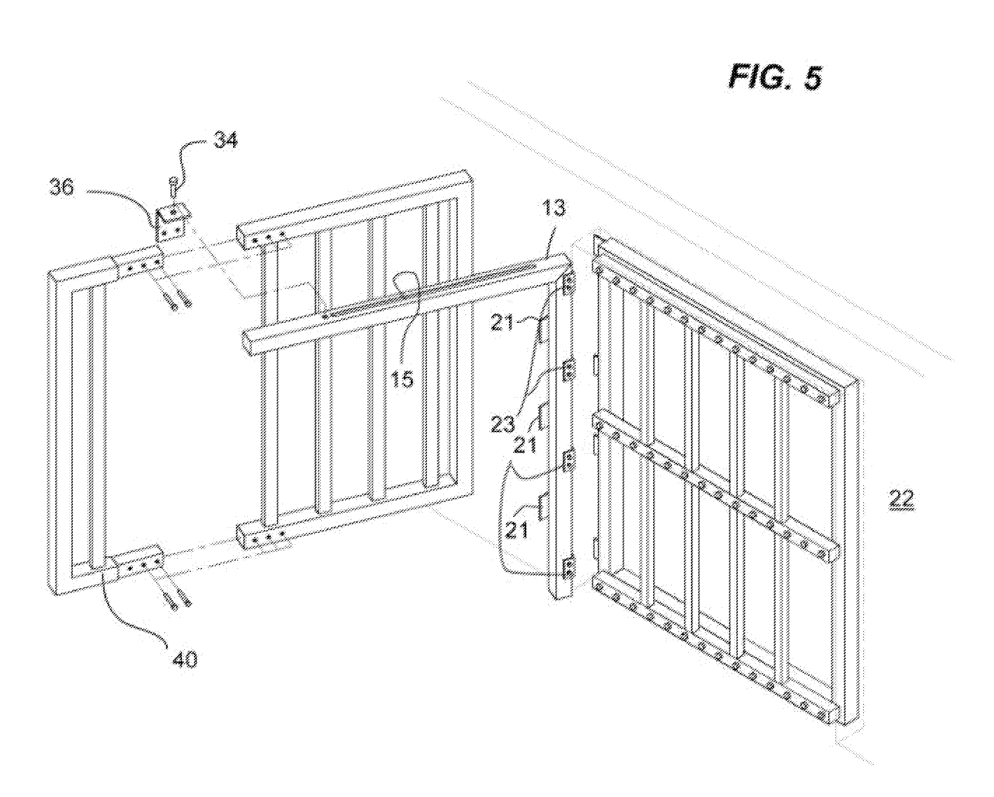

The width of the interior door (12) can be adjusted by moving an adjustment member (40), as seen in FIG. 5.

1. A robber trapping door comprising an interior door adapted to be securely and pivotally attached to an interior surface of a wall member adjacent to an opening therethrough; an exterior door adapted to be securely and pivotally attached to an exterior surface of said wall member adjacent to said opening therethrough; and a connector member securely connected to said exterior door section, adapted to extend through said opening of said wall member, and is movably connected to said interior door section, such that said interior and exterior door sections can pivotally move in unison with one another; wherein said interior door section includes a stopper mechanism adapted to prevent said interior door section from pivoting with respect to said wall member, and thereby also preventing said exterior door section from pivoting with respect to said wall member, such that when a robber is attempting to pass through said interior and exterior door sections said stopper can be activated locking said door sections in place and trapping said robber therebetween for apprehension.

2. The robber trapping door of claim 1, wherein said exterior door section further includes an exterior door adapted to be pivotally attached to said exterior surface of said wall member adjacent to said opening therethrough; an upper frame segment adapted to be securely attached to said exterior surface of said wall member adjacent and above said opening therethrough; an exterior partition member adapted to be fixedly attached to said exterior surface of said wall member adjacent to said opening therethrough and on an opposite side from said exterior door, and wherein said exterior partition is adapted to be fixedly attached to said exterior surface of said wall member at an angle such that said exterior door, said upper frame segment, and said exterior partition member can form a triangular configuration to one another; and an exterior top panel member fixedly attached to top surfaces of said upper frame segment and said exterior partition member, and formed in a triangular shape that matches the triangular shape formed by said exterior door, said upper frame segment, and said exterior partition member when said exterior door is pivoted and locked in place by said stopper mechanism.

3. The robber trapping door of claim 2, wherein said interior door section further includes an interior door adapted to be pivotally attached to said interior surface of said wall member adjacent to said opening therethrough; an upper frame segment adapted to be securely attached to said interior surface of said wall member adjacent and above said opening therethrough; an interior partition member adapted to be fixedly attached to said interior surface of said wall member adjacent to said opening therethrough and on an opposite side from said interior door, and wherein said interior partition is adapted to be fixedly attached to said interior surface of said wall member at an angle such that said interior door, said upper frame segment, and said interior partition member can form a triangular configuration to one another; and an interior top panel member fixedly attached to top surfaces of said upper frame segment and said interior partition member, and formed in a triangular shape that matches the triangular shape formed by said interior door, said upper frame segment, and said interior partition member when said interior door is pivoted and locked in place by said stopper mechanism.

4. The robber trapping door of claim 3, wherein said stopper mechanism includes a stopper attached to said connector member; and a solenoid latch attached to said upper frame member of said interior door section, such that when said stopper mechanism is activated said stopper is securely connected to said solenoid latch, thereby locking said interior and exterior doors in positions that form said triangular shapes, and thereby form a cage that is adapted to trap said robber therein for apprehension.

5. The robber trapping door of claim 4, wherein said stopper mechanism is adapted to be activated remotely.

6. The robber trapping door of claim 1, wherein said interior door has an elongated groove within a tops surface thereof; and said connector member includes a pin extending downward therefrom that is adapted to fit and slide within said elongated groove of said interior door, thereby forming said movable connection therebetween.

7. The robber trapping door of claim 3, wherein said interior door of said interior door section includes an interior door portion; and an interior door frame member, wherein said interior door portion is pivotally connected to said interior door frame member, and said interior door frame member is adapted to be pivotally attached to said interior surface of said wall member; and wherein a top surface of said interior door portion further includes a catch member and securing lock pin adapted to releasably secure said interior door portion to said interior door frame member, such that said interior door portion can be disengaged from said interior door frame member and pivoted to an open position that would allow passage of people and equipment through said trapping door without interference from said interior or exterior door sections.

8. The robber trapping door of claim 7, wherein hinges are adapted and used to create the pivoting connections between said interior and exterior door sections and said wall member, and the pivoting connection between said interior door portion and said interior door frame member.

9. The robber trapping door of claim 7, wherein said interior door portion is adapted to be adjusted in width.

10. The robber trapping door of claim 9, wherein said interior door portion includes two telescoping sections that incorporate a series of holes and fasteners, such that said width of said interior door portion can be adjusted and secured.
